(19) United States
(12) Patent Application Publication
(10) Pub. No.: US 2025/0214154 A1
(43) Pub. Date: Jul. 3, 2025

(54) DUST COLLECTING DEVICE AND DRILLING TOOL ASSEMBLY

(71) Applicant: JIANGSU DONGCHENG TOOLS TECHNOLOGY CO., LTD, Nantong, jiangsu (CN)

(72) Inventors: Yuanwei PU, Nantong (CN); Li TONG, Nantong (CN)

(21) Appl. No.: 19/087,451

(22) Filed: Mar. 22, 2025

Related U.S. Application Data
(63) Continuation of application No. PCT/CN2023/134848, filed on Nov. 28, 2023.

(30) Foreign Application Priority Data
Nov. 30, 2022 (CN) 202211520993.6

(51) Int. Cl. B23B 47/34; B23B 45/00

(52) U.S. Cl. CPC B23B 47/34; B23B 45/003

(57) ABSTRACT

Disclosed are a dust collecting device and a drilling tool assembly, and the dust collecting device includes a main housing, a dust collecting box and a suction tube assembly mounted on the main housing, where the suction tube assembly includes an outer tube movably disposed on the main housing and an inner tube axially movably disposed in the outer tube, a suction port is provided at a front end of the inner tube, and a dust guide passage communicating with the suction port to the dust collecting box is formed in the suction tube assembly; where the suction tube assembly further comprises a locking assembly.

### CROSS-REFERENCE TO RELATED APPLICATIONS

This application is a continuation of International Application No. PCT/CN2023/134848, filed on Nov. 28, 2023, which claims priority to Chinese Patent Application No. CN202211520993.6, filed on Nov. 30, 2022, the contents of which are incorporated herein by reference in their entirety.

### TECHNICAL FIELD

The present disclosure relates to the technical field of dust collection, more particularly to a dust collecting device and a drilling tool assembly for use in conjunction with a hand-held drilling tool.

### BACKGROUND

Dust collecting device is usually used in conjunction with a hand-held drilling tool, such as an electric hammer, to collect dust and other debris during drilling operations, preventing dust and other debris from junking in the workplace.

The conventional dust collecting device, such as Japanese Invention Patent Publication No. JP6778560B2, discloses a dust collecting device for an electric tool, in which an inner cylinder retracted into the outer cylinder is locked by an operation ring provided at the front end of the outer cylinder, so as to be suitable for drill bits of two sizes. This dust collecting device can only fix the inner cylinder when the inner cylinder is retracted into the outer cylinder, and when short-stroke drilling is required using a long drill bit, it is difficult to control the depth of short-stroke drilling because the inner cylinder can freely move relative to the outer cylinder.

In view of this, it is indeed necessary to provide an improved dust collecting device and an electric tool equipped with the dust collecting device to overcome the defects of the cited art.

### SUMMARY

In view of the shortcomings of the cited art, an object of the present disclosure is to provide a dust collecting device and a drilling tool assembly to which the dust collecting device is mounted so as to be used in multiple scenarios.

The disclosure adopts a technical solution for solving the problems of the cited art: the dust collecting device comprises a main housing, a dust collecting box and a suction tube assembly mounted on the main housing, the suction tube assembly comprises an outer tube movably arranged on the main housing and an inner tube axially movably arranged inside the outer tube, a front end of the inner tube is provided with a suction port, a dust guide passage communicating with the suction port to the dust collecting box is formed in the suction tube assembly, and the suction tube assembly further comprises a locking assembly.

In a case where the locking assembly is in a first locking position, the inner tube and the outer tube are respectively axially movable relative to the main housing.

In a case where the locking assembly is in a second locking position, the inner tube is locked relative to the outer tube in a fully extended state, and an entirety formed by the inner tube and the outer tube is axially movable relative to the main housing.

In a case where the locking assembly is in a third locking position, the inner tube is at least partially retracted into the outer tube and locked inside the outer tube, the entirety formed by the inner tube and the outer tube is axially movable relative to the main housing.

In a further improvement, the locking assembly comprises a locking ring disposed on the inner tube to be movable back and forth, and the locking ring is locked with the inner tube or the outer tube in an axial rotational manner about the suction tube assembly.

In a further improvement, a side wall of the outer tube is provided with a first stop portion limiting the outer tube to move along the axial direction, the first stop portion is movable along a longitudinal direction of the outer tube, and the side wall of the outer tube is further provided with a first scale and a second scale side by side, and the first scale and the second scale are respectively located on an upper side and a lower side of the first stop portion.

In a case where the locking assembly is in the first locking position, one end of the first stop portion corresponds to the second scale to indicate a moving distance of the suction tube assembly relative to the main housing.

In a case where the locking assembly is in the second locking position or the third locking position, one end of the first stop portion corresponds to the first scale to indicate the moving distance of the suction tube assembly relative to the main housing.

In a further improvement, the other end of the first stop portion away from the suction port is provided with a stopper, the stopper is perpendicular to the first stop portion and is extended toward the suction tube assembly, and in a case where the suction tube assembly moves toward the main housing, the stopper abuts against a rear end surface of the outer tube.

In a further improvement, one end of the first stop portion close to the suction port is provided with a limiting protrusion, the limiting protrusion is perpendicular to the first stop portion and is extended outwardly, and in a case where the suction tube assembly moves toward the main housing, the stopper abuts against the locking ring.

In a further improvement, the locking assembly further comprises a first locking portion between the locking ring and the outer tube, a second locking portion and a third locking portion between the locking ring and the inner tube, and the second locking portion or the third locking portion can be simultaneously engaged with the first locking portion respectively.

In a further improvement, the first locking portion comprises at least one first limiting rib provided on the rear end surface of the locking ring and at least one first limiting slot provided on the front end of the outer tube to match with the first limiting rib, and the first limiting rib is extended along a circumferential direction of the locking ring.

In a further improvement, the second locking portion comprises at least one second limiting rib disposed on the inner surface of the locking ring and at least one second limiting slot disposed on the outer surface of the inner tube to match with the second limiting rib, and the second limiting rib is extended in the circumferential direction of the locking ring.

The third locking portion comprises the second limiting rib and at least one third limiting slot provided on the outer surface of the inner tube to match with the second limiting rib.

The outer surface of the inner tube is provided with a guiding slot extending axially along the suction tube assembly, one end of the guiding slot is communicated with the second limiting slot, and the other end is communicated with the third limiting slot.

In a further improvement, the second limiting slot is provided at the front end of the inner tube, and the third limiting slot is provided at the rear end of the inner tube.

In a further improvement, a rear edge of the second limiting slot is provided with a first elastic protrusion capable of floating radially along the inner tube, and a rear edge of the third limiting slot is provided with a second elastic protrusion capable of floating radially along the inner tube.

In a further improvement, a front end of the guiding slot is provided with a third elastic protrusion capable of floating along the radial direction of the inner tube.

Another technical solution adopted to solve the problems of the cited art is that a dust collecting device is mounted on a drilling tool, where the dust collecting device comprises a main housing, a dust collecting box and a suction tube assembly mounted on the main housing, where the suction tube assembly comprises an outer tube axially movably arranged on the main housing, an inner tube axially movably arranged inside the outer tube, a locking assembly and a first stop portion limiting the outer tube to move backward, where a front end of the inner tube is provided with a suction port, and a dust guide passage communicating with the suction port to the dust collecting box is formed in the suction tube assembly. The locking assembly locks the inner tube at different positions in the outer tube, a side wall of the outer tube is provided with a first scale and a second scale arranged side by side and extended in an axial moving direction, the first stop portion is adjustably locked on the main housing with reference to the first scale and the second scale, the moving distance of the suction tube assembly relative to the main housing is displayed by the first scale in at least one locking position of the inner tube, and the moving distance of the suction tube assembly relative to the main housing is displayed by the second scale in at least another locking position of the inner tube.

In a further improvement, a guide rail extended along the longitudinal direction is fixedly arranged on the outer tube, and the first stop portion is movably arranged in the guide rail.

In a further improvement, the first stop portion comprises a first snap portion extended along the longitudinal direction of the outer tube, the main housing is provided with a first operation portion, the first operation portion comprises a second snap portion, and the first operation portion is pressed to adjust the locking position of the first snap portion and the second snap portion to adjustably lock the first stop portion with the main housing.

In a further improvement, the first snap portion is a first tooth row, the second snap portion is a second tooth row matched with the first tooth row, and the length of the second tooth row is smaller than the length of the first tooth row.

In a further improvement, in a case where the locking assembly is located at the first locking position, the inner tube and the outer tube can respectively move axially relative to the main housing, and one end of the first stop portion corresponds to the second scale to indicate a moving distance of the suction tube assembly relative to the main housing.

In a case where the locking assembly is located in the second locking position, the inner tube is locked relative to the outer tube in the extended state, an entirety formed by the inner tube and the outer tube is axially movable relative to the main housing, and one end of the first stop portion corresponds to the first scale to indicate a moving distance of the suction tube assembly relative to the main housing.

In a case where the locking assembly is located in the third locking position, the inner tube portion is retracted in the outer tube and locked inside the outer tube, the entirety formed by the inner tube and the outer tube is axially movable relative to the main housing, and one end of the first stop portion corresponds to the first scale to indicate a moving distance of the suction tube assembly relative to the main housing.

In a further improvement, the locking assembly further comprises a first locking portion between the locking ring and the outer tube, a second locking portion and a third locking portion between the locking ring and the inner tube, and the second locking portion or the third locking portion can be simultaneously engaged with the first locking portion respectively.

The first locking portion comprises at least one first limiting rib disposed on the rear end surface of the locking ring and at least one first limiting slot disposed on the front end of the outer tube and matched with the first limiting rib, wherein the first limiting rib is circumferentially extended along the locking ring.

The second locking portion comprises at least one second limiting rib disposed on the inner surface of the locking ring and at least one second limiting slot disposed on the outer surface of the inner tube to match with the second limiting rib, the second limiting rib is extended circumferentially along the locking ring.

The third locking portion comprises the second limiting rib and at least one third limiting slot provided on the outer surface of the inner tube to match with the second limiting rib.

In a further improvement, the outer surface of the inner tube is provided with a guiding slot extending along the axial direction of the suction tube assembly, one end of the guiding slot is communicated with the second limiting slot, the other end is communicated with the third limiting slot, the second limiting slot is provided at the front end of the inner tube, and the third limiting slot is provided at the rear end of the inner tube.

In a further improvement, the rear edge of the second limiting slot is provided with a first elastic protrusion capable of floating radially along the inner tube, the rear edge of the third limiting slot is provided with a second elastic protrusion capable of floating radially along the inner tube, and the front end of the guiding slot is provided with a third elastic protrusion capable of floating radially along the inner tube.

In a further improvement, the other end of the first stop portion away from the suction port is provided with a stopper, the stopper is perpendicular to the first stop portion and is extended toward the suction tube assembly, and in a case where the suction tube assembly moves toward the main housing, the stopper abuts against a rear end surface of the outer tube.

In a further improvement, one end of the first stop portion close to the suction port is provided with a limiting protrusion, the limiting protrusion is perpendicular to the first stop portion and is extended outwardly, and in a case where the suction tube assembly moves toward the main housing, the stopper abuts against the locking ring.

In a further improvement, the suction tube assembly further comprises a second stop portion fixed on the side wall of the outer tube, the second stop portion comprises a third snap portion extended along the longitudinal direction of the outer tube, the main housing is provided with a second operation portion, the second operation portion comprises a fourth snap portion, and the locking position of the third snap portion and the fourth snap portion is adjusted by pressing the second operation portion to adjust the distance of the outer tube extending out of the main housing.

In a further improvement, the third snap portion is a third tooth row, the fourth snap portion is a fourth tooth row matched with the third tooth row, and the length of the fourth tooth row is smaller than the length of the third tooth row.

In a further improvement, a drilling tool assembly is provided, the drilling tool assembly having a drilling tool and a dust collecting device mounted on the drilling tool.

Compared with the cited art, the disclosure has the following beneficial effects: by arranging the locking assembly on the suction tube assembly, the inner tube is locked in the outer tube by rotating the locking ring in the locking assembly, the inner tube can be locked when at least partially retracted or fully is extended out of the outer tube, and the inner tube can be avoided from freely moving relative to the outer tube when the dust collecting device is adapted to the long drill bit for short-stroke drilling, so as to facilitate controlling the depth of short-stroke drilling of the long drill bit and is adaptable in multiple scenarios.

Also, by arranging the first scale and the second scale side by side on the side wall of the outer tube, the moving distance of the suction tube assembly relative to the main housing is displayed by the first scale in at least one locking position of the inner tube, and the moving distance of the suction tube assembly relative to the main housing is displayed by the second scale in at least another locking position, so that the dust collecting device can accurately control the drilling depth when adapting to different length drill bits and having different drilling depth requirements.

### BRIEF DESCRIPTION OF THE DRAWINGS

Specific embodiments of the present disclosure will be described in further detail below with reference to the accompanying drawings.

FIG. 1 is a schematic structural diagram of a dust collecting device according to an embodiment of the present disclosure.

FIG. 2 is a structural explosive view of the suction tube assembly according to the embodiment of the present disclosure.

FIG. 3 is a partially enlarged schematic view at A in FIG. 2.

FIG. 4 is a partially enlarged schematic view at B in FIG. 2.

FIG. 5 is a partially enlarged schematic view at C in FIG. 2.

FIG. 6 is another structural explosive view of the suction tube assembly according to the embodiment of the present disclosure.

FIG. 7 is a schematic structural view of FIG. 2 in which the inner tube is not locked in the outer tube by the locking ring.

FIG. 8 is a schematic structural view of FIG. 2 in which the inner tube is locked in the outer tube by the locking ring when the inner tube is fully extended out of the outer tube.

FIG. 9 is a schematic structural view of FIG. 2 in which the inner tube is locked in the outer tube by the locking ring when the inner tube is fully retracted into the outer tube.

FIG. 10 is a schematic diagram of the dust collecting device according to the embodiment of the present disclosure adapted to a long drill bit for long-stroke drilling.

FIG. 11 is a schematic diagram of the dust collecting device according to the embodiment of the present disclosure adapted to a long drill bit for short-stroke drilling.

FIG. 12 is a schematic diagram of the dust collecting device according to the embodiment of the present disclosure adapted to a short bit for drilling.

FIG. 13 is a partial schematic view of the suction tube assembly received in the main housing according to the embodiment of the present disclosure.

FIG. 14 is a schematic view of a side of the suction tube assembly having a second stop portion according to the embodiment of the present disclosure.

### DETAILED DESCRIPTION OF THE EMBODIMENTS

The terminology used in the present disclosure is for the purpose of describing particular embodiments only, and is not intended to limit the present disclosure. Words indicating orientation or positional relationships such as “front” and “rear” described below are based solely on the orientation or positional relationships shown in the drawings and are only for the purpose of facilitating the description of the disclosure and simplifying the description, and do not indicate or imply that the device/element referred to must have a particular orientation or be constructed and operated in a particular orientation, and are therefore not to be construed as limiting the disclosure.

The present disclosure will be described in further detail below with reference to the accompanying drawings and embodiments.

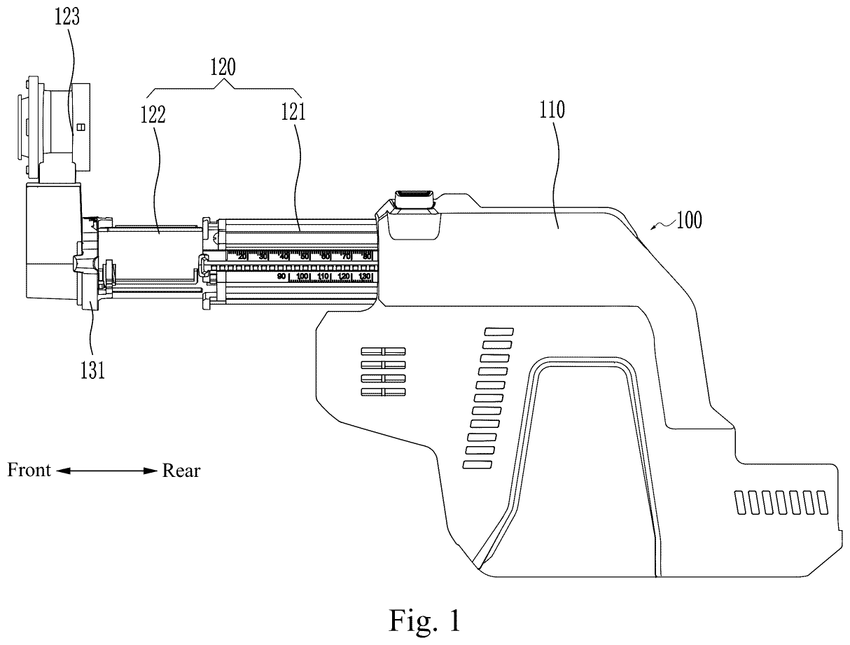

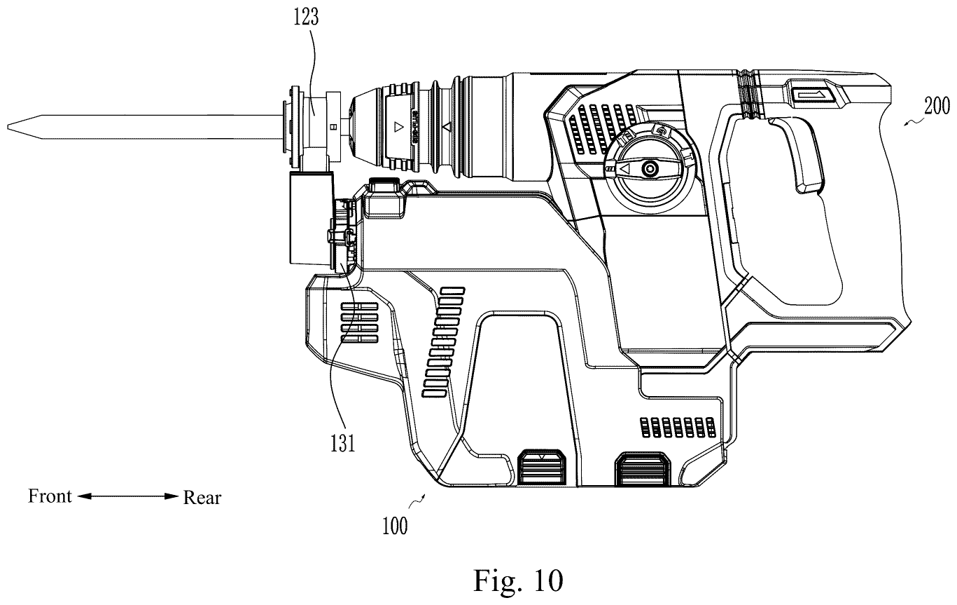

With reference to FIGS. 10 to 12, a drilling tool assembly according to an embodiment of the present disclosure is shown. The drilling tool assembly comprises a drilling tool and a dust collecting device 100 mounted on the drilling tool for collecting dust and other debris during drilling using the drilling tool. In the present embodiment, the drilling tool is an electric hammer 200. With reference to FIG. 1, the dust collecting device 100 comprises a main housing 110 in which a dust collecting box (not shown) for storing dust and other debris is provided, a filter (not shown) is provided on the dust collecting box. A suction tube assembly 120 is provided on the main housing 110, the suction tube assembly 120 comprises an outer tube 121 movably disposed on the main housing 110 and an inner tube 122 movably disposed in the outer tube 121 movably back and forth, a dust guide passage communicated with the dust collecting box is formed in the suction tube assembly 120, and a suction port 123 communicated with the dust guide passage is provided at the front end of the inner tube 122, and dust and other debris enter the dust guide passage through the suction port 123 and reach the dust collecting box.

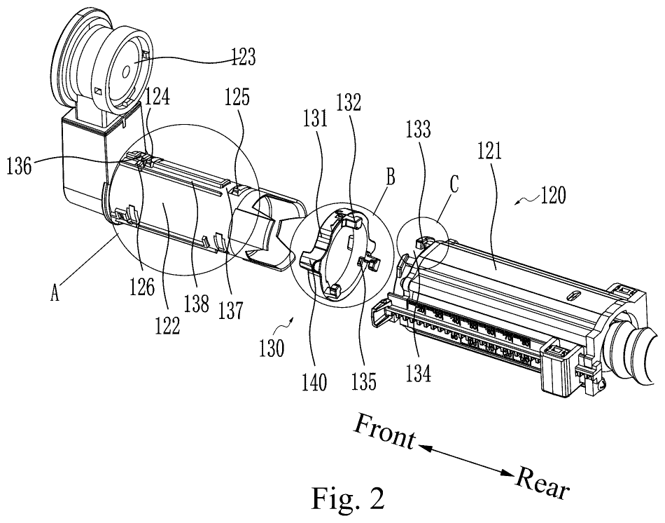

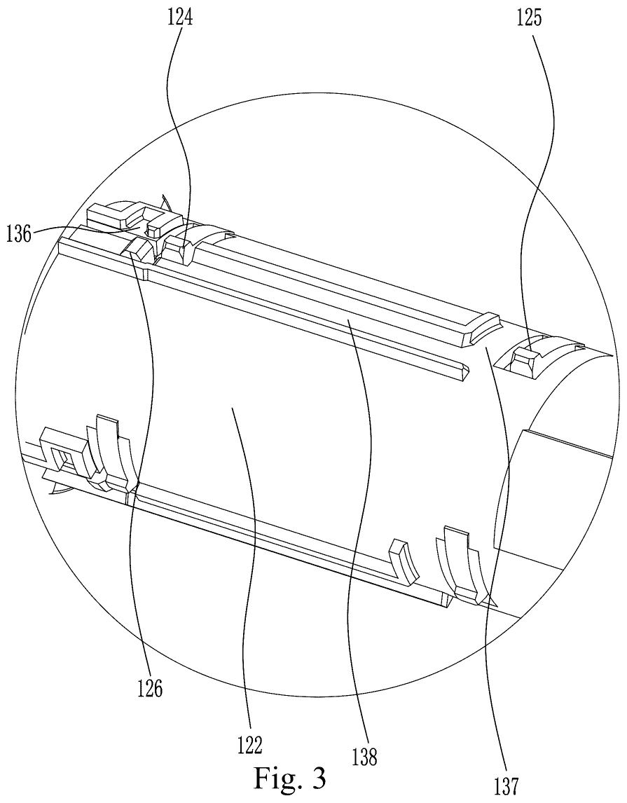

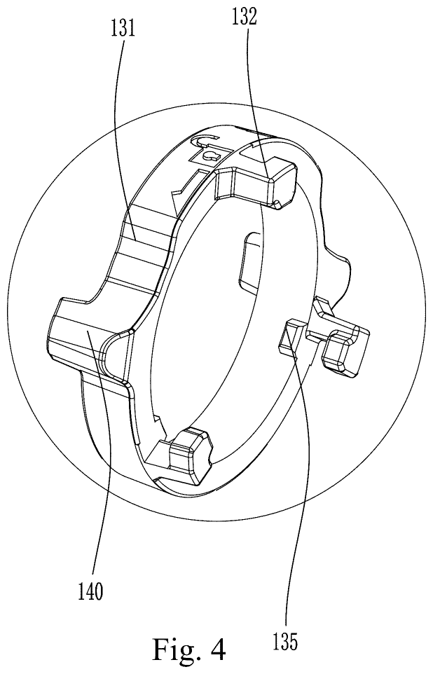

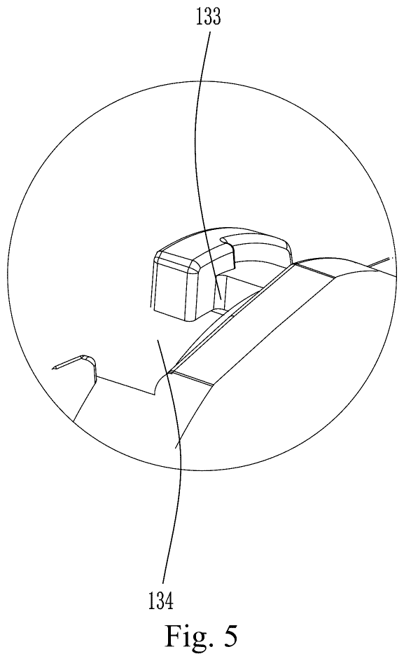

With reference to FIGS. 1-5, the suction tube assembly 120 further comprises a locking assembly 130 that locks the inner tube 122 into the outer tube 121 when the inner tube 122 is fully retracted or fully extended out of the outer tube 121.

The locking assembly 130 comprises a locking ring 131 movably disposed on the inner tube 122, the locking ring 131 locks the inner tube 122 in the outer tube 121 in a rotational manner about the suction tube assembly 120. A first locking portion is provided between the locking ring 131 and the outer tube 121, a second locking portion and a third locking portion are provided between the locking ring 131 and the inner tube 122, and the second locking portion or the third locking portion can be simultaneously engaged with the first locking portion respectively, to lock the inner tube and the outer tube.

The first locking portion comprises at least one first limiting rib 132 provided on the rear end surface of the locking ring 131 and at least one first limiting slot 133 provided on the front end of the outer tube 121 and matched with the first limiting rib 132, the first limiting rib 132 extending along the circumferential direction of the locking ring 131. The starting end of the first limiting slot 133 is provided with an opening 134 through which the first limiting rib 132 passes, and when the first limiting rib 132 is extended into the opening 134, the locking ring 131 is rotated along the extension direction of the first limiting slot 133, so that the first limiting rib 132 can be embedded in the first limiting slot 133 and interlocked, so the first locking portion is engaged. Optionally, three first limiting ribs 132 are provided at equal intervals along the circumferential direction on the rear end surface of the locking ring 131, and correspondingly, three first limiting slots 133 are provided at equal intervals along the circumferential direction at the front end of the outer tube 121.

The second locking portion comprises at least one second limiting rib 135 provided on the inner surface of the locking ring 131 and at least one second limiting slot 136 provided on the outer surface of the inner tube 122 to match with the second limiting rib 135, the second limiting rib 135 extending circumferentially along the locking ring 131. The third locking portion comprises a second limiting rib 135 and at least one third limiting slot 137 provided on the outer surface of the inner tube 122 to match with the second limiting rib 135. The outer surface of the inner tube 122 is provided with a guiding slot 138 extending along the axial direction of the suction tube assembly 120, and one end of the guiding slot 138 is communicated with the second limiting slot 136, and the other end is communicated with the third limiting slot 137. Specifically, the second limiting slot 136 and the third limiting slot 137 are provided on the same side of the guiding slot 138, and when the lock ring 131 is moved so that the second limiting rib 135 reaches the second limiting slot 136 or the third limiting slot 137, the second limiting rib 135 can be embedded in the second limiting slot 136 or the third limiting slot 137 and interlocked by rotating the lock ring 131 along the extending direction of the second limiting slot 136 or the third limiting slot 137, so the second lock portion or the third lock portion is engaged. Optionally, three second limiting ribs 135 are arranged at equal intervals along the circumferential direction on the inner surface of the locking ring 131, and correspondingly, three second limiting slots 136 and three third limiting slots 137 are arranged at equal intervals along the circumferential direction on the outer surface of the inner tube 122.

In the embodiment, in order to realize simultaneous engagement of the second locking portion or the third locking portion when the first locking portion is engaged, the extending directions of the first limiting slot 133, the second limiting slot 136, and the third limiting slot 137 are the same. Further, the first limiting slot 133, the second limiting slot 136, and the third limiting slot 137 are located on the same side as the guiding slot 138.

In the present embodiment, the second limiting slot 136 is provided at the front end of the inner tube 122, that is, the second limiting slot 136 is provided adjacent to the suction port 123. The third limiting slot 137 is provided at the rear end of the inner tube 122, that is, the third limiting slot 137 is provided adjacent to the outer tube 121. Thus, when the second limiting rib 135 is embedded in the second limiting slot 136, the inner tube 122 is locked in the outer tube 121 in a fully retracted state, and when the second limiting rib 135 is embedded in the third limiting slot 137, the inner tube 122 is locked in the outer tube 121 in a fully extended state.

The rear side edge of the second limiting slot 136 is provided with a first elastic protrusion 124 that can float in the radial direction of the inner tube 122, and the rear side edge of the third limiting slot 137 is provided with a second elastic protrusion 125 that can float in the radial direction of the inner tube 122.

When it is necessary to engage the second locking portion, the locking ring 131 is rotated along the extending direction of the second limiting slot 136, and the first limiting rib 132 presses the first elastic protrusion 124 and crosses the first elastic protrusion 124. The second limiting rib 135 is embedded in the second limiting slot 136, and the first elastic protrusion 124 cooperates with the first limiting rib 132 to prevent the locking ring 131 from rotating under non-human action, thereby preventing the second locking portion from being unlocked during drilling of the electric hammer 200, for example.

When it is necessary to engage the third locking portion, the locking ring 131 is rotated along the extending direction of the third limiting slot 137, and the first limiting rib 132 presses the second elastic protrusion 125 and crosses the second elastic protrusion 125. The second limiting rib 135 is embedded in the third limiting slot 137, and the second elastic protrusion 125 cooperates with the first limiting rib 132 to prevent the locking ring 131 from rotating under non-human action, thereby preventing the third locking portion from being unlocked during drilling of the electric hammer 200, for example.

The front end of the guiding slot 138 is provided with a third elastic protrusion 126 that can float in the radial direction of the inner tube 122. When it is not necessary to lock the inner tube 122 on the outer tube 121, the locking ring 131 is limited at a position adjacent to the suction port 123, and when it is necessary to axially move the locking ring 131 along the inner tube 122, the movement of the second stopping rib 135 in the guiding slot 138 needs to cross the third elastic protrusion 126, and the cooperation between the second stopping rib 135 and the third elastic protrusion 126 can prevent the locking ring 131 from moving from the position adjacent to the suction port 123 toward the outer tube 121 under non-human action.

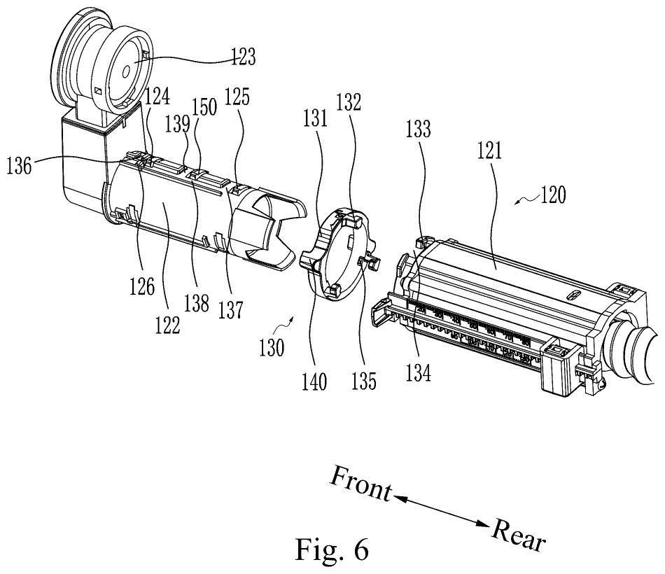

With reference to FIG. 6, in other embodiments, at least one additional limiting slot can be further provided on the outer surface of the inner tube 122 as needed, and at least one additional locking portion can be formed in cooperation with the second limiting rib 135. Taking one additional limiting slot as an example, the limiting slot is a fourth limiting slot 139, which can be provided at any position between the second limiting slot 136 and the third limiting slot 137, and correspondingly, the rear side edge of the fourth limiting slot 139 is provided with a fourth elastic protrusion 150. In this way, the dust collecting device 100 can be adapted to drill bits of a variety of sizes.

With continued reference to FIGS. 1 to 6, at least one flange 140 is provided on the outer surface of the locking ring 131, and the flange 140 is extended radially outward along the locking ring 131. Optionally, the outer surface of the locking ring 131 is provided with two flanges 140, and the two flanges 140 are disposed mirror-symmetrically with the central axis of the suction tube assembly 120 as the axis of symmetry. By providing the flange 140, it is possible to easily rotate the lock ring 131.

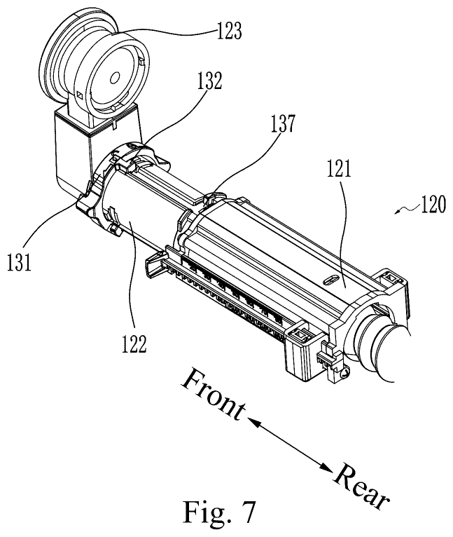

With reference to FIG. 7, when it is not necessary to lock the inner tube 122 to the outer tube 121, the locking ring 131 is placed adjacent to the suction port 123.

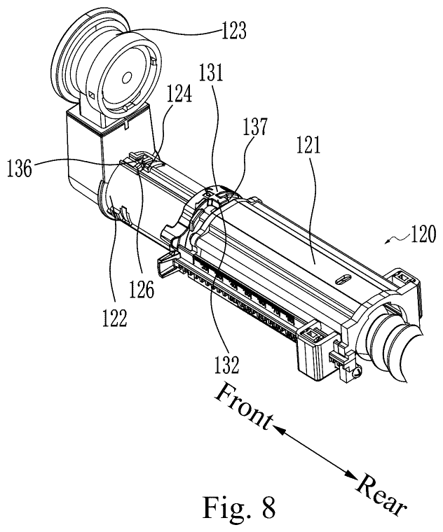

With reference to FIG. 8, when it is necessary to lock the inner tube 122 in the outer tube 121 in a fully extended state, the lock ring 131 is moved to a position adjacent to the outer tube 121, the lock ring 131 is rotated along the direction in which the first limiting slot 133 is extended, the first limiting rib 132 is embedded in the first limiting slot 133, and the second limiting rib 135 is embedded in the third limiting slot 137, so the first locking portion and the third locking portion are engaged, and the inner tube 122 is locked inside the outer tube 121.

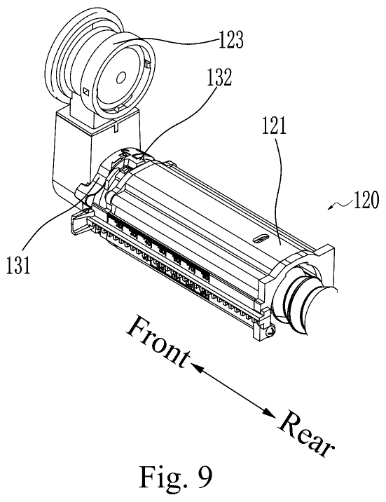

With reference to FIG. 9, when it is necessary to lock the inner tube 122 in the outer tube 121 in a fully retracted state, the lock ring 131 is moved to a position adjacent to the suction port 123, the lock ring 131 is rotated along the direction in which the first limiting slot 133 is extended, the first limiting rib 132 is embedded in the first limiting slot 133, and the second limiting rib 135 is embedded in the second limiting slot 136, so the first locking portion and the second locking portion are engaged, and the inner tube 122 is locked inside the outer tube 121.

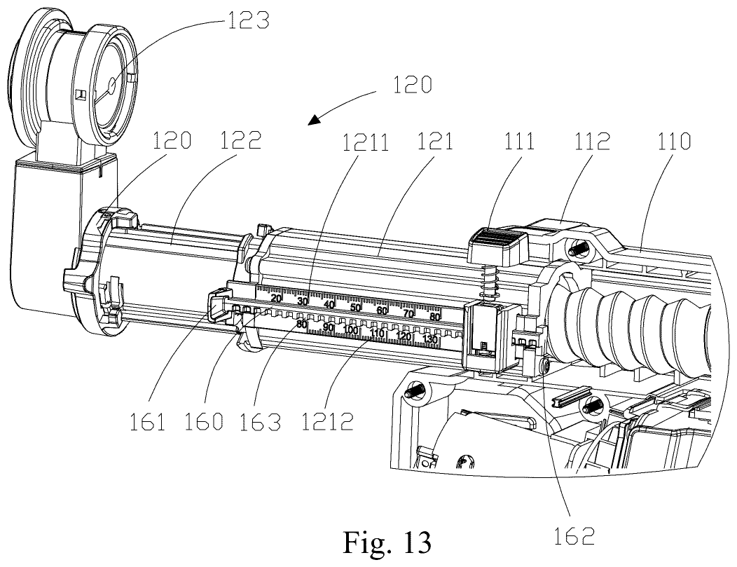

With reference to FIG. 13, the main housing 110 of the dust collecting device 100 is provided with a first operation portion 111, and a guide rail (not shown) extending in the longitudinal direction and a first stop portion 160 movably provided in the guide rail are fixed to the side wall of the outer tube 121. In the present embodiment, the guide rail and the outer tube 121 are integrally formed. The first stop portion 160 is employed to limit the distance that the suction tube assembly 120 can move toward the main housing 110. The first operation portion 111 has a first position and a second position relative to the main housing 110. The first operation portion 111 can be a first button assembly, where the first position indicates a position on the main housing 110 when the first button assembly is not pressed, and the second position indicates a position on the main housing 110 when the first button assembly is pressed. The first operation portion 111 comprises a second snap portion (not shown), and the first stop portion 160 comprises a first snap portion 163. In a case where the first operation portion 111 is at the first position, the second snap portion engages with the first snap portion 163, thereby preventing the first stop portion 160 from moving relative to the outer tube 121. In a case where the first operation portion 111 is at the second position, the second snap portion is separated from the first snap portion 163, thereby allowing the first stop portion 160 to move relative to the outer tube 121. Specifically, the first snap portion 163 is a first tooth row, the second snap portion is a second tooth row matched with the first tooth row, and the length of the second tooth row is smaller than the length of the first tooth row.

The side wall of the outer tube 121 is provided with a first scale 1211 and a second scale 1212 arranged side by side and extended in the axial moving direction, the first scale 1211 and the second scale 1212 are respectively located on the upper side and the lower side of the first stop portion 160, and the first stop portion 160 is adjustably locked to the main housing 110 by the first operation portion 111 referring to the first scale 1211 and the second scale 1212. In the embodiment, as shown in FIG. 13, the units of the first scale 1211 and the second scale 1212 can be millimeters, the value of the first scale 1211 can be “20 to 80”, and the value of the second scale 1212 can be “80 to 130”.

The first stop portion 160 is provided with a limiting protrusion 161 facing one end of the suction port 123, and a stopper 162 is provided at the other end away from the suction port 123. The limiting protrusion 161 is perpendicular to the first stop portion 160 and extended in a direction away from the suction tube assembly 120. The limiting protrusion 161 is used to indicate the value of the first scale 1211 or the second scale 1212, i.e. when the first stop portion 160 is moved, a certain reading of the limiting protrusion 161 pointing to the first scale 1211 or the second scale 1212 indicates the distance the suction tube assembly 120 can move toward the main housing 110. Also, the limiting protrusion 161 can also be used as a handle to move the first stop portion 160. The operator can push the limiting protrusion 161 to move the first stop portion 160.

The stopper 162 is perpendicular to the first stop portion 160 and extended toward the direction of the suction tube assembly 120. On the one hand, when the first stop portion 160 is pulled toward the suction port 123, the stopper 162 can abut against the rear end surface of the outer tube 121 to prevent the first stop portion 160 from being completely pulled out of the main housing 110. On the other hand, when the suction tube assembly 120 moves toward the main housing 110, the stopper 162 abuts against the rear end surface of the outer tube 121 to prevent continued movement of the suction tube assembly 120. In other embodiments, when the suction tube assembly 120 is moved toward the main housing 110, the abutment of the stop portion tab 161 against the locking ring 131 can also prevent the continued movement of the suction tube assembly 120.

With reference to FIGS. 10 to 12, when the locking assembly 130 is located at different locking positions, the moving distance of the suction tube assembly 120 with respect to the main housing 110 is displayed by different scales, that is, when the dust collecting device 100 adapts to drill bits of different sizes and has different drilling depth requirements, the drilling depth can be accurately controlled. The following takes a long drill bit and a short drill bit as examples for illustration.

With reference to FIG. 10, the dust collecting device 100 is mounted to the electric hammer 200, the front end of the electric hammer 200 is mounted with a long drill bit, and the long drill bit passes through the suction port 123 from rear to front. When it is necessary to use the long drill bit for long-stroke drilling, the locking assembly 130 is located at the first locking position, the locking ring 131 is held at the foremost end of the inner tube 122 by the third elastic protrusion 126, the inner tube 122 is not locked in the outer tube 121, the inner tube 122 and the outer tube 121 can move axially relative to the main housing 110 respectively. The drilling stroke of the long drill bit is the sum of the stroke of the inner tube 122 fully retracted inside the outer tube 121 and the stroke of the outer tube 121 fully retracted inside the main housing 110, that is, the drilling stroke corresponds to the second scale 1212 indicated by the limiting protrusion 161.

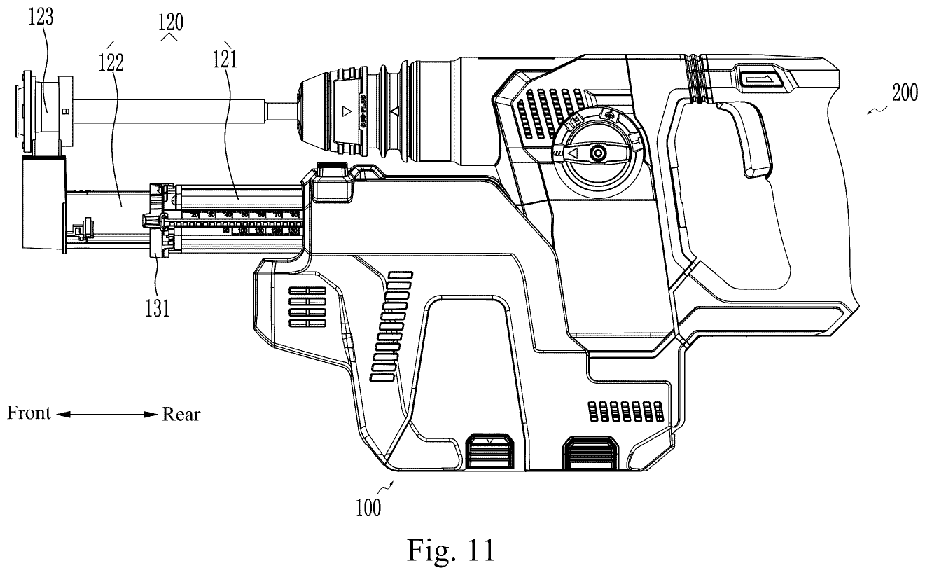

With reference to FIG. 11, the dust collecting device 100 is mounted to the electric hammer 200, the front end of the electric hammer 200 is mounted with a long drill bit, and the long drill bit passes through the suction port 123 from rear to front. When it is necessary to use a long drill bit for short-stroke drilling, the locking assembly 130 is located at the second locking position, the first locking portion and the third locking portion are engaged simultaneously, the locking ring 131 is axially stopped by the first locking portion and circumferentially stopped by the third locking portion, the inner tube 122 is locked in the outer tube 121 in a fully extended state, the entirety formed by the inner tube 122 and the outer tube 121 can be axially moved relative to the main housing 110. The drilling stroke of the long drill bit is the stroke of the outer tube 121 fully retracted inside the main housing 110, that is, the drilling stroke corresponds to the first scale 1211 indicated by the limiting protrusion 161.

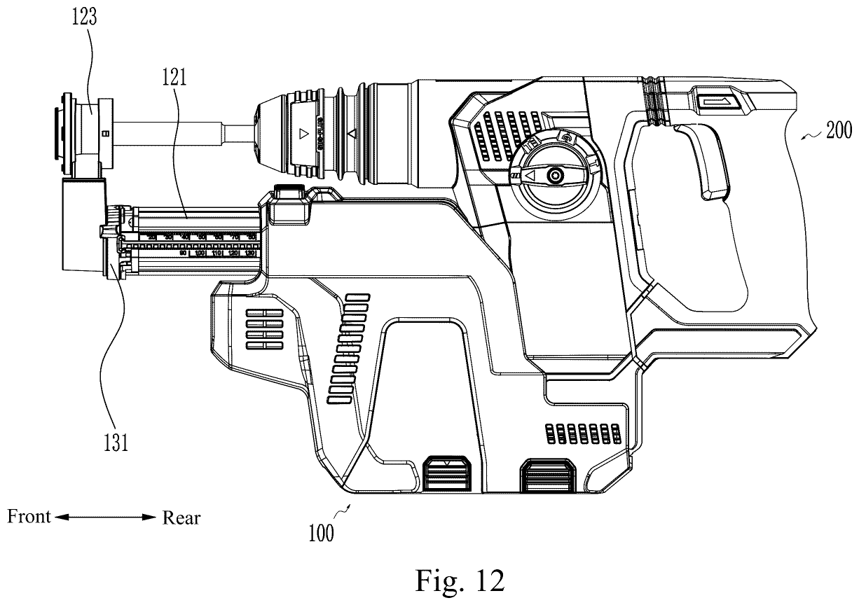

With reference to FIG. 12, the dust collecting device 100 is mounted to the electric hammer 200, the front end of the electric hammer 200 is mounted with a short drill bit, and the short drill bit passes through the suction port 123 from rear to front. When a short drill bit needs to be used for drilling, the locking assembly 130 is located in the third locking position, the first locking portion and the second locking portion are engaged simultaneously, the locking ring 131 is axially stopped by the first locking portion and circumferentially stopped by the second locking portion, the inner tube 122 is locked in the outer tube 121 in a fully retracted state, the entirety formed by the inner tube 122 and the outer tube 121 can be axially moved relative to the main housing 110. The drilling stroke of the short drill bit corresponds to the stroke of the outer tube 121 fully retracted into the main engine housing 110, that is, the drilling stroke corresponds to the first scale 1211 indicated by the limiting protrusion 161.

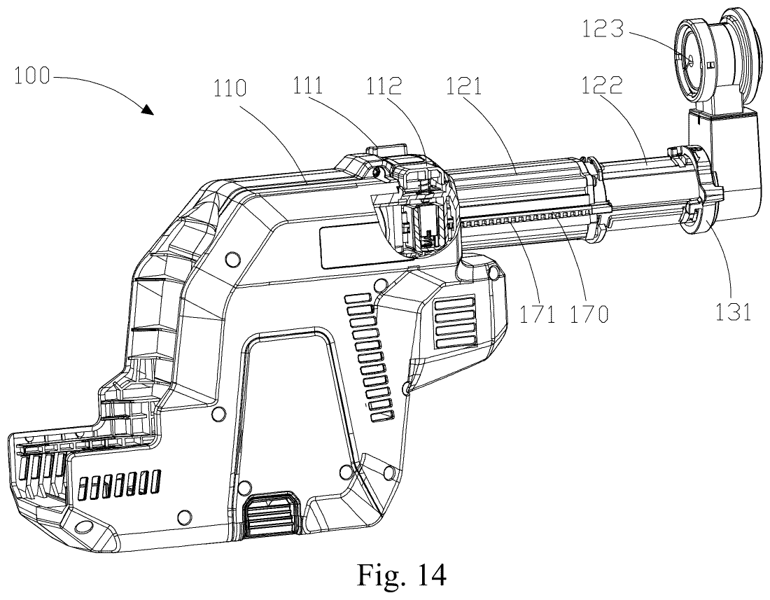

With reference to FIG. 14, the main housing 110 of the dust collecting device 100 is provided with a second operation portion 112, and a second stop portion 170 is fixed on the side wall of the outer tube 121, and the second stop portion 170 cooperates with the second operation portion 112 to limit the moving distance of the suction tube assembly 120 away from the main housing 110. The second operation portion 112 has a first position and a second position relative to the main housing 110, and the second operation portion 112 can be a second button assembly, where the first position indicates a position at the main housing 110 when the second button assembly is not pressed, and the second position indicates a position at the main housing 110 when the second button assembly is pressed. The second operation portion 112 comprises a fourth snap portion (not shown), and the second stop portion 170 comprises a third snap portion 171. In a case where the second operation portion 112 is at the first position, the fourth snap portion engages with the third snap portion 171, thereby preventing the outer tube 121 from moving relative to the main housing 110. In a case where the second operation portion 112 is at the second position, the fourth snap portion is separated from the third snap portion 171, thereby allowing the outer tube 121 to move relative to the main housing 110. Specifically, the third snap portion 171 is a third tooth row, the fourth snap portion is a fourth tooth row matched with the third tooth row, and the length of the fourth tooth row is smaller than the length of the third tooth row. By pressing the second operation portion 112, the distance at which the outer tube 121 is extended from the main housing 110 is adjusted to adapt to drill bits of different lengths.

In summary, by providing the locking assembly 130 on the suction tube assembly 120, the inner tube 122 is locked in the outer tube 121 by rotating the locking ring 131 in the locking assembly 130, at least the inner tube 122 can be locked when partially retracted or fully extended out of the outer tube 121, and the inner tube 122 can be avoided from moving freely relative to the outer tube 121 when the dust collecting device 100 is adapted to the long drill bit for short-stroke drilling, which is convenient to control the depth of short-stroke drilling and is adaptable in multiple scenarios.

Also, by arranging the first scale 1211 and the second scale 1212 side by side on the side wall of the outer tube 121, the moving distance of the suction tube assembly 120 relative to the main housing 110 is displayed by the first scale 1211 in at least one locking position of the inner tube 122, and the moving distance of the suction tube assembly 120 relative to the main housing 110 is displayed by the second scale 1212 in at least another locking position, so that the dust collecting device 100 can accurately control the drilling depth when adapting to different length drill bits and having different drilling depth requirements.

The present disclosure is not limited to the above-described embodiments. One of ordinary skill in the art will readily appreciate that there are many alternatives to the dust collecting device 100 of the present disclosure without departing from the principles and scope of the present disclosure. The scope of protection of the present disclosure is subject to the contents of the claims.

What is claimed is:

1. A dust collecting device, comprising:
a main housing, a dust collecting box and a suction tube assembly mounted on the main housing, wherein the suction tube assembly comprises an outer tube movably disposed on the main housing and an inner tube axially movably disposed in the outer tube, a suction port is provided at a front end of the inner tube, and a dust guide passage communicating with the suction port to the dust collecting box is formed in the suction tube assembly;
wherein the suction tube assembly further comprises a locking assembly;
in case where the locking assembly is in a first locking position, the inner tube and the outer tube are respectively axially movable relative to the main housing;
in case where the locking assembly is in a second locking position, the inner tube is locked relative to the outer tube in a fully extended state, and an entirety formed by the inner tube and the outer tube is axially movable relative to the main housing; and
in case where the locking assembly is in a third locking position, the inner tube is at least partially retracted into the outer tube and locked inside the outer tube, the entirety formed by the inner tube and the outer tube is axially movable relative to the main housing.

2. The dust collecting device according to claim 1, wherein the locking assembly comprises a locking ring movably disposed on the inner tube back and forth, and the locking ring is locked with the inner tube or the outer tube in an axial rotational manner about the suction tube assembly.

3. The dust collecting device according to claim 2, wherein a first stop portion is provided on a side wall of the outer tube to limit the outer tube to move in the axial direction, the first stop portion is movable along a longitudinal direction of the outer tube, a first scale and a second scale are arranged side by side on the side wall of the outer tube, and the first scale and the second scale are respectively located on the upper side and the lower side of the first stop portion;
in case where the locking assembly is in the first locking position, one end of the first stop portion corresponds to the second scale to indicate a moving distance of the suction tube assembly relative to the main housing; and
in case where the locking assembly is in the second locking position or the third locking position, one end of the first stop portion corresponds to the first scale to indicate the moving distance of the suction tube assembly relative to the main housing.

4. The dust collecting device according to claim 3, wherein the other end of the first stop portion away from the suction port is provided with a stopper, the stopper is perpendicular to the first stop portion and extended toward the suction tube assembly, and in case where the suction tube assembly moves toward the main housing, the stop portion abuts against a rear end surface of the outer tube.

5. The dust collecting device according to claim 3, one end of the first stop portion close to the suction port is provided with a limiting protrusion, the limiting protrusion is perpendicular to the first stop portion and is extended outwardly, and in case where the suction tube assembly moves toward the main housing, the stopper abuts against the locking ring.

6. The dust collecting device according to claim 2, wherein the locking assembly further comprises a first locking portion between the locking ring and the outer tube, a second locking portion and a third locking portion between the locking ring and the inner tube, and the second locking portion or the third locking portion is capable of being simultaneously engaged with the first locking portion respectively.

7. The dust collecting device according to claim 6, wherein the first locking portion comprises at least one first limiting rib provided on the rear end surface of the locking ring and at least one first limiting slot provided on a front end of the outer tube to match with the first limiting rib, and the first limiting rib is extended circumferentially along the locking ring.

8. The dust collecting device according to claim 7, wherein the second locking portion comprises at least one second limiting rib provided on the inner surface of the locking ring and at least one second limiting slot provided on the outer surface of the inner tube to match with the second limiting rib, the second limiting rib is extended circumferentially along the locking ring;
the third locking portion comprises the second limiting rib and at least one third limiting slot provided on the outer surface of the inner tube to match with the second limiting rib; and
the outer surface of the inner tube is provided with a guiding slot extending axially along the suction tube assembly, one end of the guiding slot is communicated with the second limiting slot, and the other end is communicated with the third limiting slot.

9. The dust collecting device according to claim 8, wherein the second limiting slot is provided at the front end of the inner tube, and the third limiting slot is provided at the rear end of the inner tube;
wherein a rear edge of the second limiting slot is provided with a first elastic protrusion capable of floating radially along the inner tube, and a rear edge of the third limiting slot is provided with a second elastic protrusion capable of floating radially along the inner tube; and
wherein a front end of the guiding slot is provided with a third elastic protrusion capable of radially floating along the inner tube.

10. A drilling tool assembly, comprising a drilling tool and a dust collecting device according to claim 1 mounted on the drilling tool.

11. A dust collecting device, for mounting on a drilling tool, comprising:
a main housing, a dust collecting box mounted on the main housing, and a suction tube assembly, wherein the suction tube assembly comprises an outer tube axially movably disposed on the main housing, an inner tube axially movably disposed in the outer tube, a locking assembly, and a first stop portion to limit the outer tube to move backward, wherein a suction port is provided at a front end of the inner tube, and a dust guide passage communicating with the suction port to the dust collecting box is formed in the suction tube assembly;
wherein the locking assembly locks the inner tube at different positions in the outer tube, a side wall of the outer tube is provided with a first scale and a second scale arranged side by side and extended in an axial moving direction, the first stop portion is adjustably locked on the main housing referring with the first scale and the second scale, a moving distance of the suction tube assembly relative to the main housing is displayed by the first scale in at least one locking position of the inner tube, and the moving distance of the suction tube assembly relative to the main housing is displayed by the second scale in at least another locking position of the inner tube.

12. The dust collecting device according to claim 11, wherein the outer tube is fixedly provided with a guide rail extending in a longitudinal direction of the outer tube, and the first stop portion is movably disposed in the guide rail.

13. The dust collecting device according to claim 12, wherein the first stop portion comprises a first snap portion extending along the longitudinal direction of the outer tube, the main housing is provided with a first operating portion, the first operating portion comprises a second snap portion, and the first operating portion is pressed to adjust a locking position of the first snap portion and the second snap portion to adjustably lock the first stop portion with the main housing.

14. The dust collecting device according to claim 13, wherein the first snap portion is a first tooth row, the second snap portion is a second tooth row matched with the first tooth row, and a length of the second tooth row is smaller than a length of the first tooth row.

15. The dust collecting device according to claim 11, wherein in case where the locking assembly is located in the first locking position, the inner tube and the outer tube are respectively axially movable relative to the main housing, and one end of the first stop portion corresponds to a second scale to indicate a moving distance of the suction tube assembly relative to the main housing;
in case where the locking assembly is located in the second locking position, the inner tube is locked relative to the outer tube in an extended state, an entirely formed by the inner tube and the outer tube is axially movable relative to the main housing, and one end of the first stop portion corresponds to the first scale to indicate a moving distance of the suction tube assembly relative to the main housing; and
in case where the locking assembly is located in the third locking position, the inner tube is partially retracted in the outer tube and locked in the outer tube, the entirety formed by the inner tube and the outer tube is axially movable relative to the main housing, and one end of the first stop portion corresponds to the first scale to indicate a moving distance of the suction tube assembly relative to the main housing.

16. The dust collecting device according to claim 15, wherein the locking assembly comprises a locking ring, a first locking portion between the locking ring and the outer tube, a second locking portion and a third locking portion between the locking ring and the inner tube, and the second locking portion or the third locking portion is capable of being simultaneously engaged with the first locking portion respectively;
the first locking portion comprises at least one first limiting rib disposed on the rear end surface of the locking ring and at least one first limiting slot disposed on the front end of the outer tube and matched with the first limiting rib, and the first limiting rib is circumferentially extended along the locking ring;
the second locking portion comprises at least one second limiting rib disposed on an inner surface of the locking ring and at least one second limiting slot disposed on an outer surface of the inner tube to match with the second limiting rib, the second limiting rib is extended circumferentially along the locking ring; and
the third locking portion comprises the second limiting rib and at least one third limiting slot provided on the outer surface of the inner tube to match with the second limiting rib.

17. The dust collecting device according to claim 16, wherein the outer surface of the inner tube is provided with a guiding slot extending axially along the suction tube assembly, one end of the guiding slot is communicated with the second limiting slot, the other end is communicated with the third limiting slot, the second limiting slot is provided at the front end of the inner tube, and the third limiting slot is provided at the rear end of the inner tube; and
wherein the rear edge of the second limiting slot is provided with a first elastic protrusion capable of floating radially along the inner tube, the rear edge of the third limiting slot is provided with a second elastic protrusion capable of floating radially along the inner tube, and the front end of the guiding slot is provided with a third elastic protrusion capable of floating radially along the inner tube.

18. The dust collecting device according to claim 15, wherein the other end of the first stop portion away from the suction port is provided with a stopper, the stopper is perpendicular to the first stop portion and extended toward the suction tube assembly, and when the suction tube assembly moves toward the main housing, the stopper abuts against the rear end surface of the outer tube; and
wherein one end of the first stop portion close to the suction port is provided with a limiting protrusion, the limiting protrusion is perpendicular to the first stop portion and is extended outwardly, and when the suction tube assembly moves toward the main housing, the stopper abuts against the locking ring.

19. The dust collecting device according to claim 11, wherein the suction tube assembly further comprises a second stop portion fixed on the side wall of the outer tube, the second stop portion comprises a third snap portion extending along the longitudinal direction of the outer tube, the main housing is provided with a second operation portion, the second operation portion comprises a fourth snap portion, and the locking position of the third snap portion and the fourth snap portion is adjusted by pressing the second operation portion to adjust the distance of the outer tube extending from the main housing; and
wherein the third snap portion is a third tooth row, the fourth snap portion is a fourth tooth row matched with the third tooth row, and a length of the fourth tooth row is smaller than a length of the third tooth row.

20. A drilling tool assembly, comprising a drilling tool and a dust collecting device according to claim 13 mounted on the drilling tool.
